(19) United States
(12) Patent Application Publication
(10) Pub. No.: US 2024/0047699 A1
(43) Pub. Date: Feb. 8, 2024

(54) ELECTROLYTE FILLING USING MICROCHANNELS

(71) Applicant: Rivian IP Holdings, LLC, Plymouth, MI (US)

(72) Inventors: Ashish NIGAM, Saint Joseph, MI (US); Rajeev DHIMAN, Pleasanton, CA (US); Christopher Surya KOMPELLA, Saratoga, CA (US)

(21) Appl. No.: 17/883,157

(22) Filed: Aug. 8, 2022

(51) Int. Cl. H01M 4/76; H01M 4/66; H01M 4/04

(52) U.S. Cl. CPC H01M 4/76; H01M 4/663; H01M 4/0404; H01M 4/0428; H01M 4/0435

(57) ABSTRACT

Provided is an electrode comprising a current collector, a base layer on a surface of the current collector, and an active material (e.g., cathode, anode) layer on the base layer. The base layer comprises microchannels that are at least partially horizontally aligned with respect to the first surface of the current collector. Also provided are methods for preparing electrodes and electrode assemblies, and methods of filling liquid electrolyte into electrode assemblies. Electric vehicle systems comprising the electrode assemblies are also provided.

### INTRODUCTION

This disclosure is generally directed to electrodes (e.g., cathodes, anodes) and electrode assemblies comprising microchannels, which are useful in lithium-ion batteries. Also provided are methods for preparing electrodes and electrode assemblies that are expected to reduce the overall cost of lithium-ion batteries comprising such electrodes and electrode assemblies.

### BRIEF SUMMARY

In one aspect, as depicted in FIG. 1, provided herein is an electrode comprising a current collector, a first base layer on a first surface of the current collector, and a first active material (e.g., cathode, anode) layer on the first base layer. The first base layer comprises microchannels that are at least partially horizontally aligned with respect to the first surface of the current collector. In some embodiments, as depicted in FIG. 2, the electrode further comprises a second base layer on a second surface of the current collector and a second active material (e.g., cathode, anode) layer on the second base layer. In these embodiments, the second base layer also comprises microchannels that are at least partially horizontally aligned with respect to the second surface of the current collector. In some embodiments, the base layer may comprise a material that contains microchannels (e.g., carbon nanotubes, carbon nanopipes, or a combination thereof). In other embodiments, voids within the base layer may constitute the microchannels. In some embodiments, an electrode of any of the preceding embodiments may be incorporated into an electrode assembly that may additionally comprise a separator (e.g., a porous polymer or porous membrane). An electrode assembly of the preceding embodiment may be useful in, for example, the preparation of an electrochemical cell, such as a lithium-ion battery. In these embodiments, liquid electrolyte is filled into the electrode assembly. In some embodiments, the presence of the microchannels in the base layer(s) reduces the time required to fill the liquid electrolyte into the electrode assembly, as compared to an electrode assembly that does not comprise a base layer with microchannels. In some embodiments, the presence of the microchannels in the base layer(s) improves the wettability of the electrode assembly, thereby increasing the extent of contact between the liquid electrolyte and the components of the electrode assembly.

In some embodiments, provided herein is an electrode comprising: a current collector; a first base layer on a first surface of the current collector, wherein the first base layer comprises microchannels; and a first active material layer on the first base layer; wherein at least a portion of the microchannels of the first base layer are at least partially horizontally aligned with respect to the first surface of the current collector.

In some embodiments, the electrode may further comprise: a second base layer on a second surface of the current collector, wherein the second base layer comprises microchannels; and a second active material layer on the second base layer; wherein at least a portion of the microchannels of the second base layer are at least partially horizontally aligned with respect to the second surface of the current collector.

In some embodiments, a cross-section of each of the microchannels may be circular. In other embodiments, a cross-section of each of the microchannels may be polygonal (e.g., rectagonal, hexagonal, pentagonal).

In some embodiments, the microchannels may be arranged in a staggered structure. In other embodiments, the microchannels may be arranged in a honeycomb structure.

In some embodiments, the average diameter of the microchannels may be between about 1 nm and about 10,000 nm. In some embodiments, the average pitch of the microchannels (i.e., the average spacing between microchannels) may be between about 1 nm and about 10 mm. In some embodiments, the average length of the microchannels may be between about 1 μm and about 10,000 μm.

In some embodiments, the average orientation of the microchannels may be parallel to a long axis of the first surface. In other embodiments, the average orientation of the microchannels may be parallel to a short axis of the first surface.

In some embodiments, the thickness of the first base layer may be less than about 10 μm. In some embodiments, the thickness of the second base layer may be less than about 10 μm.

In some embodiments, the first active material layer may comprise cathode active material. In other embodiments, the first active material layer may comprise anode active material. In any of the preceding embodiments, the first active material layer may comprise a lithium intercalation active material. In any of the preceding embodiments, the first active material layer may comprise conductive carbon particles. In any of the preceding embodiments, the first active material layer may comprise a binder. In any of the preceding embodiments, the first active material layer may comprise or a combination of a lithium intercalation active material, conductive carbon particles, and a binder.

In some embodiments, the second active material layer may comprise cathode active material. In other embodiments, the second active material layer may comprise anode active material. In any of the preceding embodiments, the second active material layer may comprise a lithium intercalation active material. In any of the preceding embodiments, the second active material layer may comprise conductive carbon particles. In any of the preceding embodiments, the second active material layer may comprise a binder. In any of the preceding embodiments, the second active material layer may comprise or a combination of a lithium intercalation active material, conductive carbon particles, and a binder.

In some embodiments, the surface area of the first base layer may be greater than 50% of the area of the first surface of the current collector. In some embodiments, the surface area of the first base layer may be greater than 75% of the area of the first surface of the current collector. In some embodiments, the surface area of the first base layer may be greater than 90% of the area of the first surface of the current collector. In some embodiments, the surface area of the first base layer may be greater than 95% of the area of the first surface of the current collector. In some embodiments, the surface area of the first base layer may be greater than 99% of the area of the first surface of the current collector. In some embodiments, the surface area of the first base layer may be greater than 99.9% of the area of the first surface of the current collector.

In some embodiments, the surface area of the second base layer may be greater than 50% of the area of the second surface of the current collector. In some embodiments, the surface area of the second base layer may be greater than 75% of the area of the second surface of the current collector. In some embodiments, the surface area of the second base layer may be greater than 90% of the area of the second surface of the current collector. In some embodiments, the surface area of the second base layer may be greater than 95% of the area of the second surface of the current collector. In some embodiments, the surface area of the second base layer may be greater than 99% of the area of the second surface of the current collector. In some embodiments, the surface area of the second base layer may be greater than 99.9% of the area of the second surface of the current collector.

In some embodiments, the first base layer may be patterned, wherein the pattern consists of two or more discontinuous regions of the first base layer. In some such embodiments, the two or more discontinuous regions of the first base layer may consist of circular regions of the first base layer. In some such embodiments, the two or more discontinuous regions of the first base layer may consist of rectangular arrays of the first base layer. In some embodiments, the first base layer consists of two or more discontinuous regions of the first base layer having no regular pattern (e.g., random size and distribution).

In some embodiments, the second base layer may be patterned, wherein the pattern consists of two or more discontinuous regions of the second base layer. In some such embodiments, the two or more discontinuous regions of the second base layer may consist of circular regions of the second base layer. In some such embodiments, the two or more discontinuous regions of the second base layer may consist of rectangular arrays of the second base layer. In some embodiments, the second base layer consists of two or more discontinuous regions of the second base layer having no regular pattern (e.g., random size and distribution).

In some embodiments, the first base layer may comprise cathode material, wherein the microchannels of the first base layer consist of voids within the cathode material. In other embodiments, the first base layer may comprise anode material, wherein the microchannels of the first base layer consist of voids within the anode material. In some embodiments, the voids may be produced by laser ablation of the cathode or anode material. In other embodiments, the voids may be produced by calendaring the cathode material or the anode material with profiled rollers.

In some embodiments, the second base layer may comprise cathode material, wherein the microchannels of the second base layer consist of voids within the cathode material. In other embodiments, the second base layer may comprise anode material, wherein the microchannels of the second base layer consist of voids within the anode material. In some embodiments, the voids may be produced by laser ablation of the cathode or anode material. In other embodiments, the voids may be produced by calendaring the cathode material or the anode material with profiled rollers.

In some embodiments, the first base layer may comprise carbon nanotubes. In some such embodiments, the carbon nanotubes may be produced by chemical vapor deposition. In some embodiments, the first base layer may comprise carbon nanopipes. In some such embodiments, the carbon nanopipes may be produced by chemical vapor deposition. In some embodiments, the first base layer may comprise a combination of carbon nanotubes and carbon nanopipes.

In some embodiments, the second base layer may comprise carbon nanotubes. In some such embodiments, the carbon nanotubes may be produced by chemical vapor deposition. In some embodiments, the second base layer may comprise carbon nanopipes. In some such embodiments, the carbon nanopipes may be produced by chemical vapor deposition. In some embodiments, the second base layer may comprise a combination of carbon nanotubes and carbon nanopipes.

In some embodiments, provided herein is method of a preparing an electrode, comprising: depositing a first base layer on a first surface of a current collector, wherein the first base layer comprises microchannels; and depositing a first active material layer on the first base layer; wherein at least a portion of the microchannels of the first base layer are at least partially horizontally aligned with respect to the first surface of the current collector.

In some embodiments, the method further may comprise depositing a second base layer on a second surface of the current collector, wherein the second base layer comprises microchannels; and depositing a second active material layer on the second base layer; wherein at least a portion of the microchannels of the second base layer are at least partially horizontally aligned with respect to the second surface of the current collector.

In some embodiments, depositing the first base layer may comprise performing chemical vapor deposition. In some embodiments, depositing the first base layer may comprise performing arc discharge.

In some embodiments, depositing the second base layer may comprise performing chemical vapor deposition. In some embodiments, depositing the second base layer may comprise performing arc discharge.

In some embodiments, the method further comprises applying a gas flow to at least partially align the microchannels of the first base layer. In some embodiments, the method further comprises applying an acoustic field to at least partially align the microchannels of the first base layer. In some embodiments, the method further comprises applying a magnetic field to at least partially align the microchannels of the first base layer. In some embodiments, the method further comprises applying an electric field to at least partially align the microchannels of the first base layer.

In some embodiments, the method further comprises applying a gas flow to at least partially align the microchannels of the second base layer. In some embodiments, the method further comprises applying an acoustic field to at least partially align the microchannels of the second base layer. In some embodiments, the method further comprises applying a magnetic field to at least partially align the microchannels of the second base layer. In some embodiments, the method further comprises applying an electric field to at least partially align the microchannels of the second base layer.

In some embodiments, provided herein is a method of preparing an electrode comprising: a current collector; a first base layer on a first surface of the current collector, wherein the first base layer comprises microchannels; and a first active material layer on the first base layer; wherein at least a portion of the microchannels of the first base layer are at least partially horizontally aligned with respect to the first surface of the current collector; said method comprising: creating microchannels in an active material, thereby producing the first base layer; wherein the first base layer is contiguous with the first active material layer; and laminating the first base layer onto a first surface of the current collector. In some such embodiments, the electrode may further comprise: a second base layer on a second surface of the current collector, wherein the second base layer comprises microchannels; a second active material layer on the second base layer; wherein at least a portion of the microchannels of the second base layer are at least partially horizontally aligned with respect to the second surface of the current collector; and wherein said method further comprises: creating microchannels in an active material, thereby producing the second base layer; wherein the second base layer is contiguous with the second active material layer; and laminating the second base layer onto a second surface of a current collector.

In some embodiments, creating microchannels in the active material may comprise performing laser ablation of the active material. In other embodiments, creating microchannels in the active material may comprise calendaring the cathode material or the anode material with profiled rollers.

In some embodiments, provided herein is an electrode assembly, comprising: an anode, comprising: a current collector; a first base layer on a first surface of the current collector, wherein the first base layer comprises microchannels; an anode active material layer on the first base layer; wherein at least a portion of the microchannels of the first base layer are at least partially horizontally aligned with respect to the first surface of the current collector; a cathode, comprising: a current collector; a second base layer on a second surface of the current collector, wherein the second base layer comprises microchannels; a cathode active material layer on the base layer; wherein at least a portion of the microchannels of the second base layer are at least partially horizontally aligned with respect to the second surface of the current collector; and a separator. In some embodiments, the electrode assembly may further comprise a liquid electrolyte in contact with the anode, cathode, and separator.

In some embodiments, provided herein is an electric vehicle system comprising the electrode assembly of any of the preceding embodiments.

In some embodiments, provided herein is a method of filling a liquid electrolyte into the electrode assembly of any of the preceding embodiments, comprising: (i) applying a vacuum to the electrode assembly; (ii) contacting the electrode assembly with the liquid electrolyte; (iii) applying a pressure to the electrode assembly; and (iv) reducing the pressure to about atmospheric pressure; wherein steps (iii) and (iv) are optionally repeated sequentially between 1 and 10 times.

In some embodiments, the time required to fill the liquid electrolyte into the electrode assembly of the preceding embodiments is less than about 75% of the time required to fill the liquid electrolyte into a corresponding electrode assembly lacking the microchannels, less than about 50% of the time required to fill the liquid electrolyte into a corresponding electrode assembly lacking the microchannels, less than about 25% of the time required to fill the liquid electrolyte into a corresponding electrode assembly lacking the microchannels, or less than about 10% of the time required to fill the liquid electrolyte into a corresponding electrode assembly lacking the microchannels. In some embodiments, the time required to fill the liquid electrolyte into the electrode assembly of the preceding embodiments is less than about 75% of the time required to fill the liquid electrolyte into a corresponding electrode assembly lacking the microchannels. In some embodiments, the time required to fill the liquid electrolyte into the electrode assembly of the preceding embodiments is less than about 50% of the time required to fill the liquid electrolyte into a corresponding electrode assembly lacking the microchannels. The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 depicts an illustrative example of an electrode according to various embodiments described herein.

FIG. 2 depicts an illustrative example of an electrode according to various embodiments described herein.

FIG. 3 depicts exemplary anode, separator, and cathode layers of a typical battery.

FIG. 4 depicts an exemplary process of filling electrolyte into battery cells.

FIG. 5 illustrates electrolyte movement inside a battery cell during a typical process of filling electrolyte into battery cells.

FIG. 6 depicts an illustrative example of microchannels positioned at the interface between the current collectors and the active material layers of an exemplary battery cell.

FIG. 7 depicts a bi-directional migration profile of electrolyte into an exemplary battery cell.

FIG. 8 depicts an exemplary conventional electrode coating on a foil substrate.

FIG. 9 depicts an electrode of various embodiments described herein, comprising a carbon nanopipe layer on the first surface of the current collector.

FIG. 10 depicts an electrode of various embodiments described herein, comprising a carbon nanotube layer on the first surface of the current collector

FIG. 11 depicts an electrode of various embodiments described herein, comprising microchannels formed by creating voids in the foil substrate.

FIG. 12 depicts how calendaring the cathode or anode material with profiled rollers creates microchannels in the first or second base layer, according to various embodiments described herein.

FIGS. 13A and 13B illustrate a staggered microchannel structure and a honeycomb microchannel structure, respectively.

FIG. 13C depicts discontinuous regions of a base layer, according to various embodiments described herein.

FIG. 13D depicts a filling operation of a cell comprising rectangular or straight base layer microchannel pattern, according to various embodiments described herein.

FIG. 13E depicts a filling operation of a cell comprising blind or radiating base layer microchannel pattern, according to various embodiments described herein.

FIG. 14 depicts a process of preparing an electrode according to an exemplary method of the foregoing embodiments.

FIG. 15 depicts a process of preparing an electrode according to an exemplary method of the foregoing embodiments.

FIG. 16 illustrates a flow chart for a typical battery cell manufacturing process in accordance with some embodiments disclosed herein.

FIG. 17 depicts an illustrative example of a cross sectional view of a cylindrical battery cell in accordance with some embodiments disclosed herein.

FIG. 18 depicts an illustrative example of a cross sectional view of a prismatic battery cell in accordance with some embodiments disclosed herein.

FIG. 19 depicts an illustrative example of a cross section view of a pouch battery cell in accordance with some embodiments disclosed herein.

FIG. 20 illustrates cylindrical battery cells being inserted into a frame to form a battery module and pack in accordance with some embodiments disclosed herein.

FIG. 21 illustrates prismatic battery cells being inserted into a frame to form a battery module and pack in accordance with some embodiments disclosed herein.

FIG. 22 illustrates pouch battery cells being inserted into a frame to form a battery module and pack in accordance with some embodiments disclosed herein.

FIG. 23 illustrates an example of a cross sectional view of an electric vehicle that includes at least one battery pack in accordance with some embodiments disclosed herein.

FIG. 24 is a flowchart illustrating a method of preparing an electrode according to various embodiments described herein.

FIG. 25 is a flowchart illustrating a method of preparing an electrode according to various embodiments described herein.

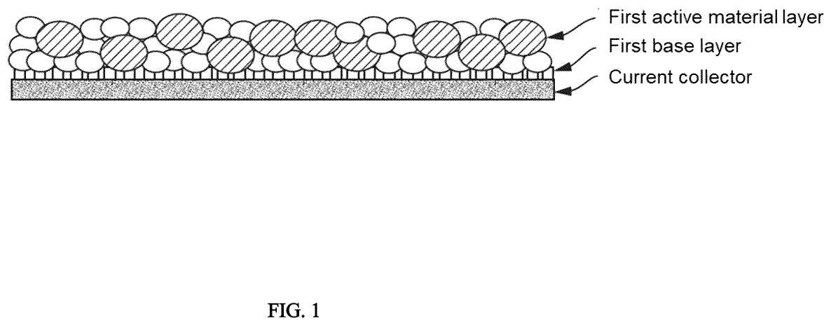

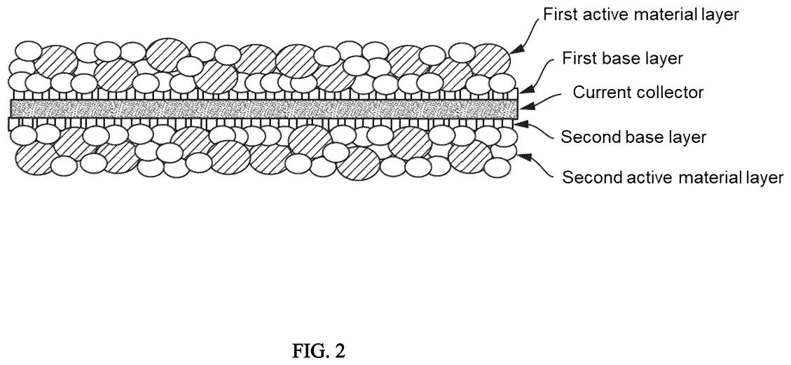

### DETAILED DESCRIPTION

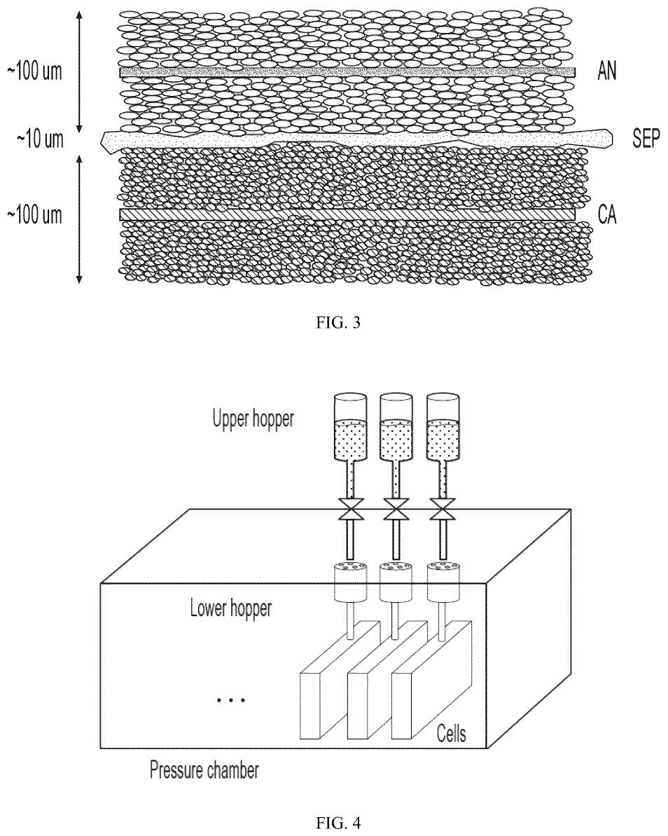

A typical battery (e.g., lithium-ion battery) comprises multiple component layers (e.g., anode, cathode, and separator) tightly packed within an enclosure, such as a metal case. The anode and cathode layers may comprise microparticle coatings of anode or cathode active material deposited on each side of a metallic foil sheet. FIG. 3 depicts exemplary anode, separator, and cathode layers of a typical battery. The total thickness of the layers may be on the order of 100 μm for the cathode and anode, while the foil may be about 10 μm thick. The anode may comprise microporous anode active material deposited on a copper foil. In some instances, the anode active material may comprise microporous graphite. Likewise, the cathode may comprise microporous cathode active material deposited on an aluminum foil. In some instances, the cathode active material may comprise microporous lithium iron phosphate. Binders and/or conductive particles may also be incorporated into the cathode and/or anode. Critically, battery cells further comprise an electrolyte to allow for the transport of ions (e.g, lithium cations) between the electrodes during charging or discharging of the cell. Frequently, the electrolyte is a liquid electrolyte that pervades the void spaces in the microporous cathode and anode layers, thereby ensuring a high degree of contact (i.e., wetting) of the cathode or anode layers with the liquid electrolyte.

In mass-scale battery manufacturing (e.g., in the production of lithium-ion batteries), the process of filing liquid electrolyte into an electrode assembly to form a complete electrochemical cell is among the slowest processes. As shown in FIG. 4, a typical process of filling electrolyte is as follows. Multiple cells are placed in a pressure chamber that can withstand negative as well as positive pressures. First, vacuum is applied on the chamber, removing air from the chamber as well as from the inside of the cells. Subsequently, electrolyte is introduced into the cells by opening a valve situated between the cell and a hopper that contains the electrolyte. Some of the electrolyte easily drips into the cell, but the rest must be forced inside for which positive pressure is applied to the chamber, typically multiple times by cycling the pressure between a high value followed by venting. The overall process may take 5 to 10 minutes. This limitation can require multiple electrolyte filling stations in a manufacturing line, which increases the cost and time of manufacturing batteries.

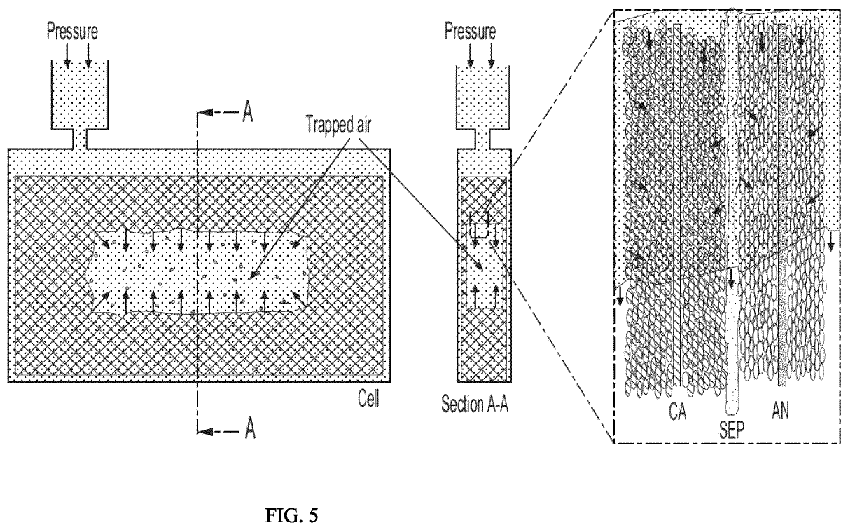

Difficulties in filling liquid electrolyte into an electrode assemblies can arise from several factors. For example, one factor that limits the speed and quality of electrolyte filling is that the components of an electrode assembly of a battery cell (e.g., cathode, anode, separator) are typically microporous materials with low porosity and high tortuosity. The low porosity and high tortuosity of these materials slows the diffusion rate of liquid electrolyte into the microporous pores of the materials, which is an essential step to ensure a high degree of contact between the electrolyte and the cell components. Additionally, the volume of electrolyte to be filled into a cell is a high percentage of the total void volume of the cell. For example, in some instances, greater than 75% of the total void volume of the cell should be filled by the electrolyte. Furthermore, residual air within the pores must be removed for the electrolyte to fill the void volume of the cell. Upon removal, residual air can become entrapped within the micropores of the cell components, further slowing the electrolyte filling process. The process of electrolyte movement inside the cell can be visualized with the help of FIG. 5. The electrolyte (dark shading in FIG. 5) moves from outside-in to the stack (shown by arrows) and traps air that could not be fully removed during the evacuation step. Within the stacked layers, the electrolyte naturally goes to the easy-to-access spaces first, which tend to be the areas at the interface of the layers, for instance the space between the anode and separator, between the cathode and separator, and the separator itself which typically has much higher porosity than the anode and cathode. This movement profile leads to pores near the foil surface to be the last ones to get wet with electrolyte. Stack wetting achieved with traditional electrolyte filling processes is typically limited to surface wetting of the electrode layers, leaving the sub-surface pores dry, especially in the center of the stack, as shown in FIG. 5. The bi-directional invasion disclosed in this invention may overcome these limitations and achieve increased wetting of electrode pores and reduce entrapment of air. In addition to the reducing the time for the electrolyte filling process, this invention may reduce the time needed for the formation process and improve cell performance and cycle life. The formation process typically lasts for 1-3 weeks where cells are situated in a controlled environment in order to thoroughly soak the stack with electrolyte. The bi-directional invasion may achieve soaking sooner, thus reducing the formation time. The improvement in soaking may manifest itself as a lower Open Circuit Voltage (OCV, up to about 30%) following the electrolyte filling and soaking processes compared with the traditional filling process. Furthermore, a better soaked cell may lead to a more uniform and robust solid electrolyte interphase (SEI) layer, which may improve cell performance and cycle life.

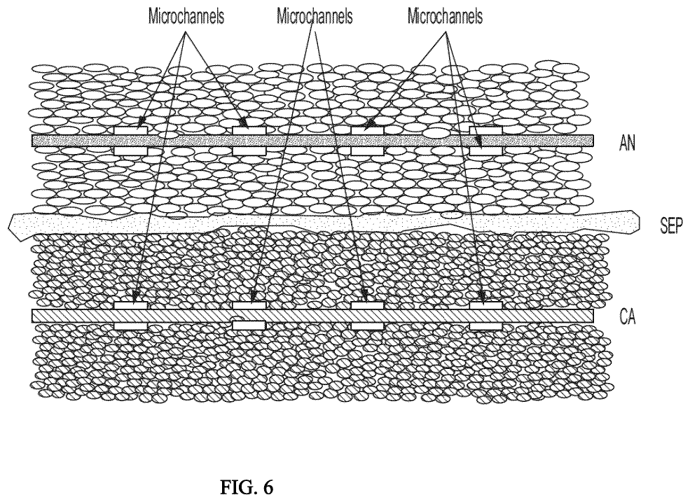

In one aspect, provided herein is, inter alia, an electrode that, when incorporated into a battery cell, enables a reduction in the time required to fill liquid electrolyte into the cell. An exemplary electrode is shown in FIG. 6. The electrode may additionally improve the wettability of the cell and allow for a higher extent of contact between liquid electrolyte and the cathode and anode layers of the cell. Methods of preparing the electrode are also provided. In addition, provided herein are methods for preparing electrode assemblies and battery cells comprising the electrode. It is expected that the electrode, electrode assemblies, battery cells, and methods described herein may provide advantages to battery cell manufacturing, such as reducing the manufacturing time and overall cost of producing batteries, such as lithium-ion batteries.

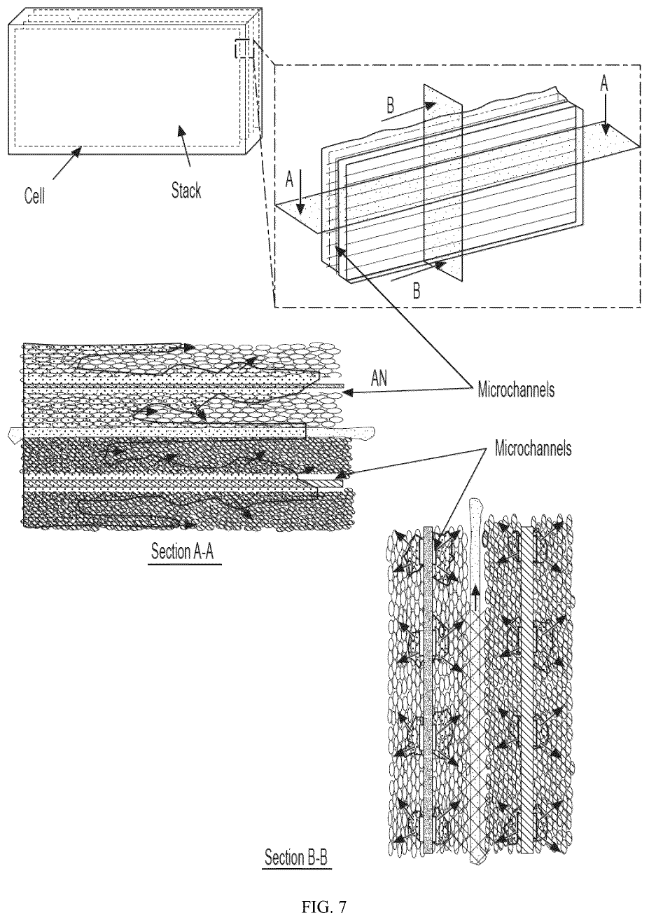

Without being bound by theory, it is surmised that, as shown in FIG. 6, providing microchannels at the interface between the current collector (e.g., the metallic foils described above) and the active material layers (e.g., the cathode or anode layers described above) facilitates electrolyte filling by providing a less-tortuous path for electrolyte invasion and air removal, thereby accelerating the wetting process and reducing the time required for electrolyte filling. With the deliberate positioning of the microchannels at the foil-coating interface, electrolyte invasion can occur at two fronts simultaneously: at the foil-coating interface and at the coating-separator interface, as shown in FIG. 7. This behavior may allow electrolyte migration from the inside-out, i.e., the areas near the foil surface may preferentially wet and migration would occur towards the coating surface, in addition to the traditional migration pattern of outside-in. This bi-directional migration profile may significantly accelerate the wetting process and thus reduce the electrolyte filling process time and cost of battery cell manufacturing.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by a person of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

As used herein, the term “horizontally aligned” will be understood by a person of ordinary skill in the art to describe the average orientation of molecules or supramolecular structures in an ordered or semi-ordered material, relative to a reference plane or a reference surface. For example, the person of ordinary skill in the art will understand that microchannels described as “horizontally aligned” may be perfectly horizontally aligned (i.e., every microchannel is parallel to a reference surface), or partially horizontally aligned (i.e., some or most microchannels are parallel to a reference surface). A plurality of microchannels described as “horizontally aligned” may contain, on average, at least 25% of the microchannels parallel to a reference surface, at least 50% of the microchannels parallel to a reference surface, at least 75% of the microchannels parallel to a reference surface, at least 90% of the microchannels parallel to a reference surface, at least 95% of the microchannels parallel to a reference surface, at least 99% of the microchannels parallel to a reference surface, or 100% of the microchannels parallel to a reference surface. A person of ordinary skill in the art further understands that microchannels described as “horizontally aligned” may comprise a plurality of microchannels for which the average orientation is perfectly parallel to a reference surface, or alternatively a plurality of microchannels for which the average orientation is not perfectly parallel to a reference surface. For example, the term “horizontally aligned” may describe a plurality of microchannels for which the vector describing the average orientation of the microchannels is at an angle relative to a reference surface. In some embodiments, the vector describing the average orientation of the microchannels may be at an angle that is less than 45 degrees relative to the reference surface, less than 30 degrees relative to the reference surface, less than 15 degrees relative to the reference surface, less than 10 degrees relative to the reference surface, or less than 5 degrees relative to the reference surface.

### Electrodes

In some embodiments, provided herein is an electrode comprising a current collector, a first base layer on a first surface of the current collector, and a first active material (e.g., cathode, anode) layer on the first base layer. The first base layer comprises microchannels that are at least partially horizontally aligned with respect to the first surface of the current collector. In some embodiments, the electrode may further comprise: a second base layer on a second surface of the current collector, wherein the second base layer comprises microchannels; and a second active material layer on the second base layer; wherein at least a portion of the microchannels of the second base layer are at least partially horizontally aligned with respect to the second surface of the current collector

In some embodiments, the current collector may include a metal that is aluminum, copper, nickel, titanium, stainless steel, or a carbonaceous material. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or a combination thereof. In another embodiment, the metal foil may be coated with carbon: e.g., carbon-coated Al foil, and the like.

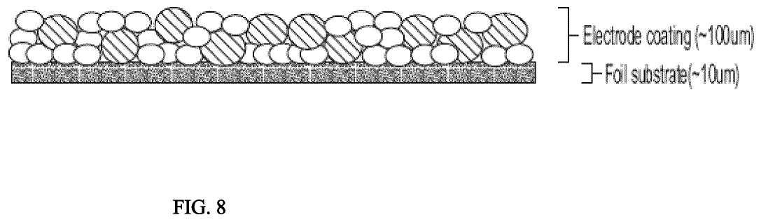

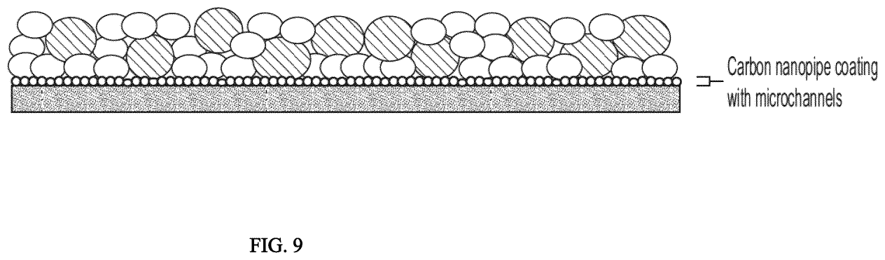

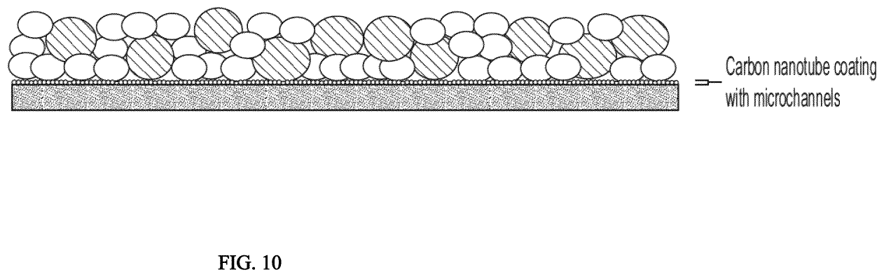

In some embodiments, the first or second base layer may be formed by depositing a material (e.g., a carbon nanotube layer, a carbon nanopipe layer) onto a surface of the current collector. Conventional electrodes consist of an electrode coating on a foil substrate, as shown in FIG. 8. In some embodiments, the traditional carbon coating used in conventional battery cells is replaced by depositing a carbon nanopipe layer onto the first or second surface of the current collector (as shown in FIG. 9), thereby forming the first or second base layer. In other embodiments, as shown in FIG. 10, the first or second base layer is formed by depositing a carbon nanotube layer onto the first or second surface of the current collector. In any of the preceding embodiments, the first or second base layer may further comprise additional material components, such as a binder or conductive carbon particles.

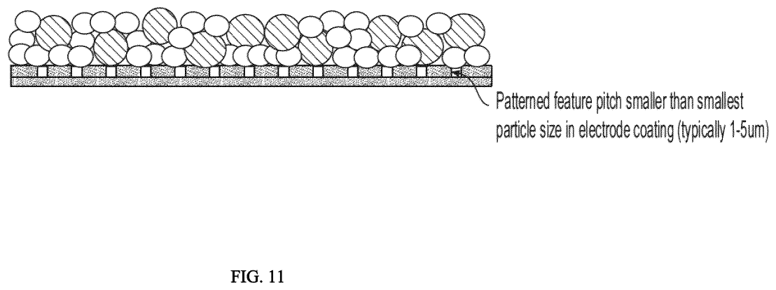

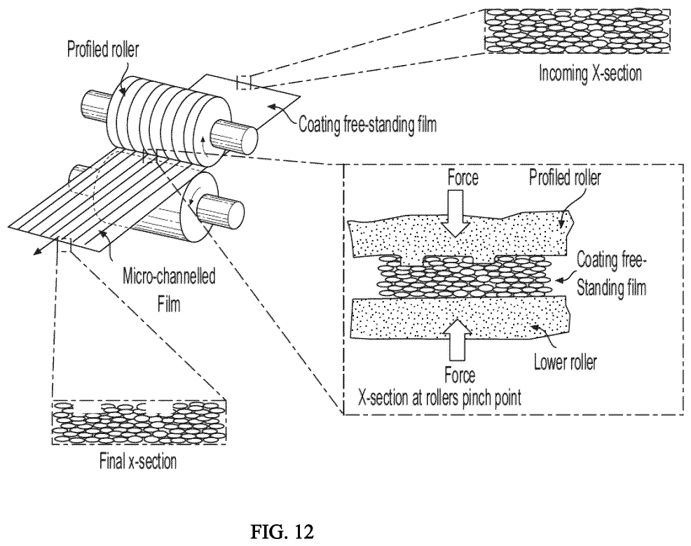

In some embodiments, the first or second base layer may be formed by creating voids in an active material layer. For example, with reference to FIG. 8, a conventional electrode consists of an electrode coating on a foil substrate. In contrast, in some embodiments of the present disclosure, the first or second base layer comprises cathode or anode material, and microchannels may be formed by creating voids in the cathode or anode material or in the foil substrate. In some embodiment, as shown in FIG. 11, the microchannels are formed by creating voids in the foil substrate. In some embodiments, laser ablation of the cathode material creates microchannels in the first or second base layer. In some embodiments, laser ablation of the anode material creates microchannels in the first or second base layer. In other embodiments, calendaring the cathode or anode material with profiled rollers creates microchannels in the first or second base layer, as shown in FIG. 12.

In some embodiments, the thickness of the first or second base layer is less than about μm. In some embodiments, the thickness of the first or second base layer is between about 0.1 and about 10 μm. In some embodiments, the thickness of the first or second base layer is less than about 5 μm. In some embodiments, the thickness of the first or second base layer is between about and about 5 μm. In some embodiments, the thickness of the first or second base layer is less than about 1 μm. In some embodiments, the thickness of the first or second base layer is between about 0.1 and about 1 μm.

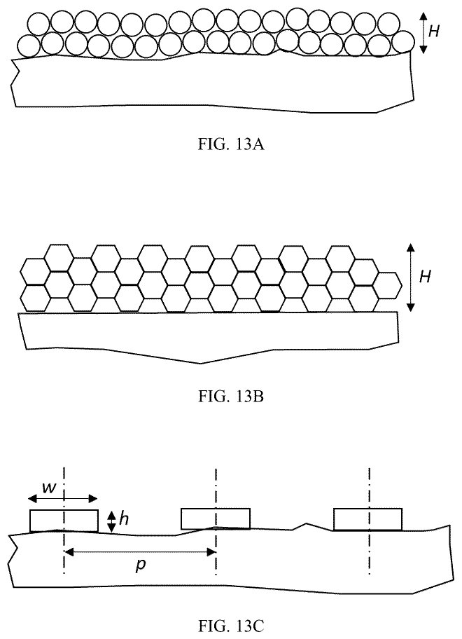

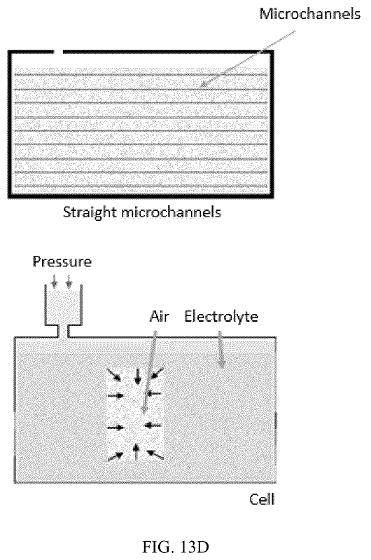

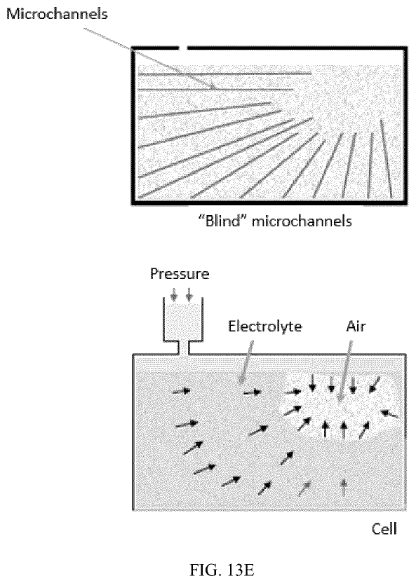

In some embodiments, a cross-section of each of the microchannels of the first or second base layer is circular. In some embodiments, a cross-section of each of the microchannels of the first or second base layer is polygonal. For example, in some embodiments, a cross-section of each of the microchannels of the first or second base layer is rectangular. In other embodiments, a cross-section of each of the microchannels of the first or second base layer is hexagonal. In other embodiments, a cross-section of each of the microchannels of the first or second base layer is square. In some embodiments, the microchannels are arranged in a staggered structure, for example as depicted in FIG. 13A. In some embodiments, the microchannels are arranged in a honeycomb structure, for example as depicted in FIG. 13B.

The microchannels may be described by their average diameter, average pitch (i.e., spacing between microchannels), and average length. In some embodiments, the average diameter of the microchannels is between about 1 nm and about 10,000 nm. In some embodiments, the average diameter of the microchannels is between about 1,000 nm and 10,000 nm. In other embodiments, the average diameter of the microchannels is between about 1 and 1,000 nm. In some such embodiments, the average diameter of the microchannels is between about 1 and 10 nm. In other embodiments, the average diameter of the microchannels is between about 10 and 1,000 nm. In some embodiments, the average pitch of the microchannels is between about 1 nm and about 10 mm. In some embodiments, the average pitch of the microchannels is between about 1 μm and about 1,000 μm. In some embodiments, the average pitch of the microchannels is between about 1 nm and 10,000 nm. In some embodiments, the average length of the microchannels is between about 1 μm and about 10,000 μm. In other embodiments, the average length of the microchannels is about the length of the electrode (e.g., the length of the current collector, the length of the first base layer, or the length of the first active material layer). In some embodiments, the first surface of the current collector has a long axis and a short axis. In some embodiments, the average orientation of the microchannels is parallel to a long axis of the first surface of the current collector. In some embodiments, the average orientation of the microchannels is parallel to a short axis of the first surface of the current collector.

In some embodiments, the first or second base layer comprises carbon nanotubes. In some embodiments, the carbon nanotubes are single-walled carbon nanotubes. In some embodiments, the carbon nanotubes are multi-walled carbon nanotubes. In some embodiments, the average diameter of the carbon nanotubes is between about 1 and 10 nm. In some embodiments, the average pitch of the carbon nanotubes is between about 1 nm and 10,000 nm. In some embodiments, the average length of the carbon nanotubes is between about 1 μm and about 10,000 μm. In some embodiments, the average diameter of the carbon nanotubes is between about 1 and 10 nm; the average pitch of the carbon nanotubes is between about 1 nm and 10,000 nm; and the average length of the carbon nanotubes is between about 1 μm and about 10,000 μm.

Carbon nanotubes can be produced according to methods known to those of ordinary skill in the art. For example, in some embodiments, the carbon nanotubes are produced by chemical vapor deposition. In some embodiments, the carbon nanotubes are deposited on the first surface of the current collector before the process of depositing an active material layer. In some embodiments, the carbon nanotubes are deposited on the first surface of the current collector during the process of depositing an active material layer.

In some embodiments, the first or second base layer comprises carbon nanopipes. In some embodiments, the average diameter of the carbon nanopipes is between about 10 and 1,000 nm. In some embodiments, the average pitch of the carbon nanopipes is between about 1 nm and nm. In some embodiments, the average length of the carbon nanopipes is between about 1 μm and about 10,000 μm. In some embodiments, the average diameter of the carbon nanopipes is between about 1 and 10 nm; the average pitch of the carbon nanopipes is between about 1 nm and nm; and the average length of the carbon nanopipes is between about 1 μm and about μm. In some embodiments, the average diameter of the carbon nanopipes is between about and 1,000 nm; the average pitch of the carbon nanopipes is between about 1 nm and 10,000 nm; and the average length of the carbon nanopipes is between about 1 μm and about 10,000 μm.

Carbon nanopipes can be produced according to methods known to those of ordinary skill in the art. For example, in some embodiments, the carbon nanopipes are produced by chemical vapor deposition. In some embodiments, the carbon nanopipes are deposited on the first surface of the current collector before the process of depositing an active material layer. In some embodiments, the carbon nanopipes are deposited on the first surface of the current collector during the process of depositing an active material layer. In some embodiments, the first base layer may comprise a combination of carbon nanotubes and carbon nanopipes. In some embodiments, the second base layer may comprise a combination of carbon nanotubes and carbon nanopipes.

In some embodiments, the surface area of the first base layer is greater than 50% of the area of the first surface of the current collector, greater than 75% of the area of the first surface of the current collector, greater than 90% of the area of the first surface of the current collector, greater than 95% of the area of the first surface of the current collector, or greater than 99% of the area of the first surface of the current collector. In some embodiments, the surface area of the first base layer is greater than 99.9% of the area of the first surface of the current collector.

In some embodiments, the surface area of the second base layer is greater than 50% of the area of the second surface of the current collector, greater than 75% of the area of the second surface of the current collector, greater than 90% of the area of the second surface of the current collector, greater than 95% of the area of the second surface of the current collector, or greater than 99% of the area of the second surface of the current collector. In some embodiments, the surface area of the second base layer is greater than 99.9% of the area of the second surface of the current collector.

In some embodiments, the first or second base layer is patterned, wherein the pattern consists of two or more discontinuous regions of the first or second base layer. For example, in some embodiments, two or more discontinuous regions of the first base layer consist of circular or semi-circular regions of the first base layer. In other embodiments, two or more discontinuous regions of the first base layer consist of rectangular or semi-rectangular arrays of the first base layer. For example, as depicted in FIG. 13C, the discontinuous regions of the first base layer consist of rectangular arrays that can be described by their width (w), height (h), and pitch (p). In some embodiments, two or more discontinuous regions of the second base layer consist of circular regions of the second base layer. In other embodiments, two or more discontinuous regions of the second base layer consist of rectangular arrays of the second base layer. In some embodiments, the first base layer consists of two or more discontinuous regions of the first base layer having no regular pattern (e.g., random size and distribution).

The pattern of the first or second base layer can reduce the time required to fill the liquid electrolyte into the electrode assembly and/or improves the wettability of the electrode assembly, as compared to an electrode assembly that does not comprise a base layer with microchannels. As an illustrative example, FIG. 5 depicts a filling operation for a battery cell in the absence of microchannels. For comparison, FIG. 13D depicts a filling operation of a battery cell comprising a rectangular or straight base layer microchannel pattern, which may allow preferential electrolyte and/or air migration in the direction of the microchannels. As another illustrative example, FIG. 13E depicts a filling operation of a cell comprising a “blind” base layer microchannel pattern having microchannels pointed to a specific preferred direction in order to achieve electrolyte and/or air migration along that direction. For example, the pattern can include microchannels configured to be directed to or point towards a corner (e.g., upper corner of the electrode assembly stack as shown in FIG. 13E, thereby directing air to migrate in that direction and to allow it to escape naturally, due to buoyancy, out of the electrode assembly stack.

In some embodiments, the first or second active material layer comprises a lithium intercalation active material. In some embodiments, the first or second active material layer comprises cathode active material. In some embodiments, the cathode active material is an olivine-type cathode active material. In some embodiments, the cathode active material is a lithium metal phosphate (e.g., lithium iron phosphate, lithium iron manganese phosphate). In other embodiments, the cathode active material can include a layered-type transition metal oxide. For example, the cathode active material can include a high-nickel content (e.g., >80% Ni) lithium transition metal oxide, such as a particulate lithium nickel manganese cobalt oxide, a lithium nickel cobalt aluminum oxide, or a lithium nickel manganese cobalt aluminum oxide. In some embodiments, the first active material layer comprises a lithium metal phosphate. In some embodiments, the second active material layer comprises a lithium metal phosphate.

In some embodiments, the first or second active material layer comprises anode active material. In some embodiments, the anode active material comprises graphitic carbon (e.g., graphite) or a silicon-based carbon composite. In some embodiments, the first active material layer comprises graphitic carbon. In some embodiments, the first active material layer comprises a silicon-based carbon composite.

In some embodiments, the first or second active material layer comprises a lithium intercalation active material, conductive carbon particles, a binder or a combination thereof. In some embodiments, the binder comprises polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

### Methods of Preparing Electrodes

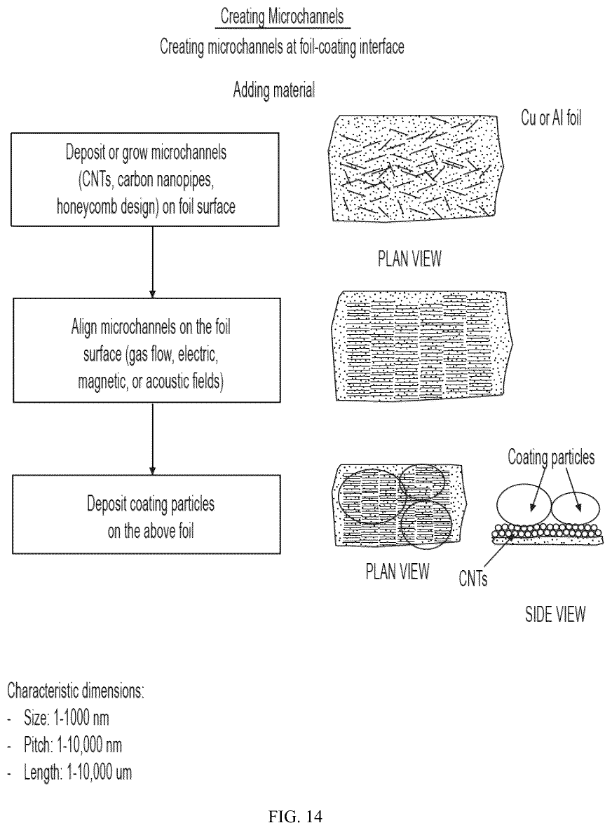

In some embodiments, provided herein is a method of preparing an electrode, comprising: depositing a first base layer on a first surface of a current collector, wherein the first base layer comprises microchannels; and depositing a first active material layer on the first base layer; wherein at least a portion of the microchannels of the first base layer are at least partially horizontally aligned with respect to the first surface of the current collector. In some embodiments, the method further comprises depositing a second base layer on a second surface of the current collector, wherein the second base layer comprises microchannels; and depositing a second active material layer on the second base layer; wherein at least a portion of the microchannels of the second base layer are at least partially horizontally aligned with respect to the second surface of the current collector. FIG. 14 depicts a process of preparing an electrode according to an exemplary method of the foregoing embodiments.

In some embodiments, depositing the first base layer comprises performing chemical vapor deposition. In some embodiments, depositing the first base layer comprises performing arc discharge.

In some embodiments, the method further comprises applying a gas flow to at least partially align the microchannels of the first base layer. In some embodiments, the method further comprises applying an acoustic field to at least partially align the microchannels of the first base layer. In some embodiments, the method further comprises applying a magnetic field to at least partially align the microchannels of the first base layer. In some embodiments, the method further comprises applying an electric field to at least partially align the microchannels of the first base layer.

In some embodiments, provided herein is a method of preparing an electrode comprising a current collector; a first base layer on a first surface of the current collector, wherein the first base layer comprises microchannels; and a first active material layer on the first base layer; wherein at least a portion of the microchannels of the first base layer are at least partially horizontally aligned with respect to the first surface of the current collector; said method comprising: creating microchannels in an active material, thereby producing the first base layer; wherein the first base layer is contiguous with the first active material layer; and laminating the first base layer onto a first surface of the current collector.

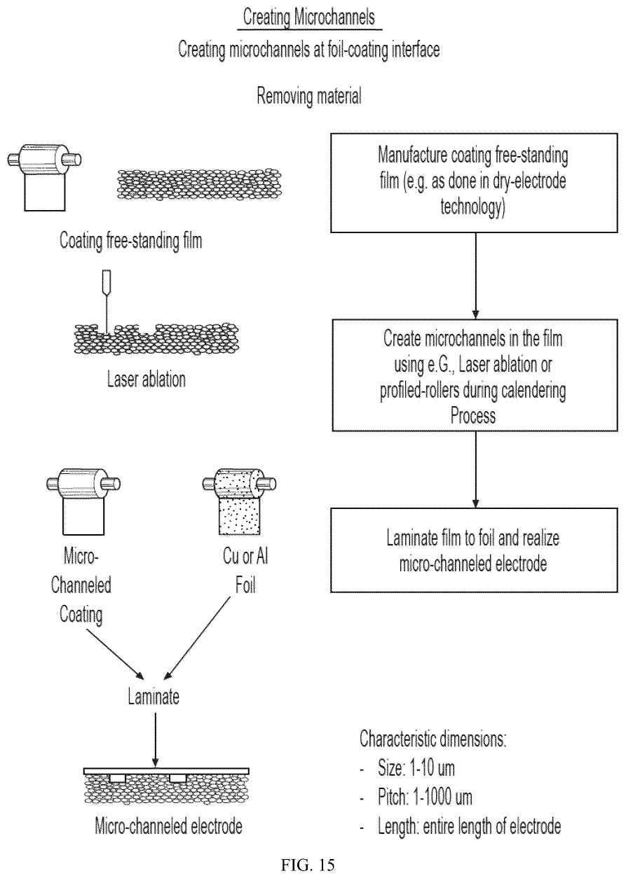

In some embodiments, the electrode further comprises: a second base layer on a second surface of the current collector, wherein the second base layer comprises microchannels; a second active material layer on the second base layer; wherein at least a portion of the microchannels of the second base layer are at least partially horizontally aligned with respect to the second surface of the current collector; and the method further comprises: creating microchannels in an active material, thereby producing the second base layer; wherein the second base layer is contiguous with the second active material layer; and laminating the second base layer onto a second surface of a current collector. In some embodiments, the active material is a lithium intercalation material. In some embodiments, the active material is cathode active material. In some embodiments, the active material is anode active material. FIG. 15 depicts a flowchart describing preparing an electrode according to an exemplary method of the foregoing embodiments.

In some embodiments, creating microchannels in the active material comprises performing laser ablation of the active material. In some embodiments, creating microchannels in the active material comprises calendaring the cathode material or the anode material with profiled rollers.

### Electrode Assemblies and Methods of Filling Electrolyte

In some embodiments, provided herein is an electrode assembly (e.g., a battery, a battery cell, an electrochemical cell), comprising: an anode, comprising: a current collector; a first base layer on a first surface of the current collector, wherein the first base layer comprises microchannels; an anode active material layer on the first base layer; wherein at least a portion of the microchannels of the first base layer are at least partially horizontally aligned with respect to the first surface of the current collector; a cathode, comprising: a current collector; a second base layer on a second surface of the current collector, wherein the second base layer comprises microchannels; a cathode active material layer on the base layer; wherein at least a portion of the microchannels of the second base layer are at least partially horizontally aligned with respect to the second surface of the current collector; and a separator.

In some embodiments, the separator comprises a porous polymer. In some embodiments, the separator comprises a porous polymer that is a polyethylene. In some embodiments, the separator comprises a porous polymer that is a polypropylene.

In some embodiments, the electrode assembly further comprises a liquid electrolyte. The liquid electrolyte may be in contact with the anode, cathode, and separator. In some embodiments, the liquid electrolyte comprises a non-polar organic solvent. In some embodiments, the non-polar organic solvent is a carbonate. In some embodiments, the liquid electrolyte comprises ethylene carbonate, propylene carbonate, diethyl carbonate, ethyl methyl carbonate, dimethyl carbonate, or a mixture of any two or more thereof. In some embodiments, the liquid electrolyte may further comprise additives such as, but not limited to, vinylidene carbonate, fluoroethylene carbonate, ethyl propionate, methyl propionate, methyl acetate, ethyl acetate, or a mixture of any two or more thereof. In some embodiments, the liquid electrolyte comprises a lithium salt. The lithium salt of the liquid electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. The salt may be present in the liquid electrolyte from greater than 0 M to about 0.5 M.

In some embodiments, provided herein is a method of filling a liquid electrolyte into the electrode assembly of any of the preceding embodiments, said method comprising: (i) applying a vacuum to the electrode assembly; (ii) contacting the electrode assembly with the liquid electrolyte; (iii) applying a pressure to the electrode assembly; and (iv) reducing the pressure to about atmospheric pressure, wherein steps (iii) and (iv) are optionally repeated sequentially between 1 and 10 times. In some embodiments, the applied vacuum is between about 1 and about 100 mbar-a. In some embodiments, the applied pressure is about 1 MPa. In some embodiments, the applied pressure is greater than about 1 MPa.

In some embodiments, the time required to fill the liquid electrolyte into the electrode assembly of the preceding embodiments is less than about 75% of the time required to fill the liquid electrolyte into a corresponding electrode assembly lacking the microchannels, less than about 50% of the time required to fill the liquid electrolyte into a corresponding electrode assembly lacking the microchannels, less than about 25% of the time required to fill the liquid electrolyte into a corresponding electrode assembly lacking the microchannels, or less than about 10% of the time required to fill the liquid electrolyte into a corresponding electrode assembly lacking the microchannels. In some embodiments, the time required to fill the liquid electrolyte into the electrode assembly of the preceding embodiments is less than about 50% of the time required to fill the liquid electrolyte into a corresponding electrode assembly lacking the microchannels.

### Battery Packs, Battery Modules, and Electric Vehicle Systems

Reference will now be made to implementations and embodiments of various aspects and variations of battery cells, battery modules, battery packs, and the methods of making such battery cells, battery modules, and battery packs. Although several exemplary variations of the battery cells, modules, packs, and methods of making them are described herein, other variations of the battery cells, modules, packs and methods may include aspects of the battery cells, modules, packs and methods described herein combined in any suitable manner having combinations of all or some of the aspects described. In addition, any part of or any of the electrodes, densified electrodes, components, systems, methods, apparatuses, devices, compositions, etc. described herein can be implemented into the battery cells, battery modules, battery packs, and methods of making these battery cells, battery modules, and battery packs.

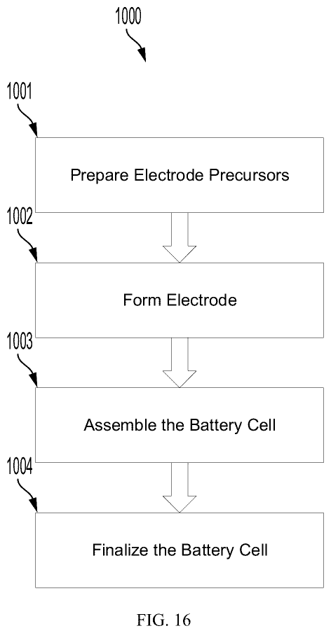

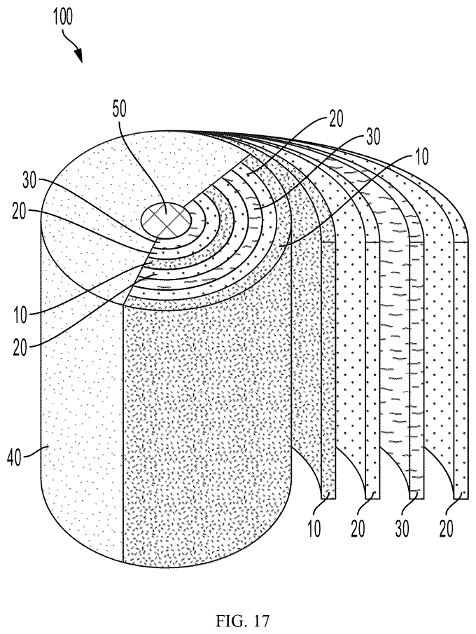

FIG. 16 illustrates a flow chart for a typical battery cell manufacturing process 1000. These steps are not exhaustive and other battery cell manufacturing processes can include additional steps or only a subset of these steps. At step 1001, the electrode precursors (e.g., binder, active material, conductive carbon additive) can be prepared. In some embodiments, this step can include mixing electrode materials (e.g., active materials) with additional components (e.g., binders, solvents, conductive additives, etc.) to form an electrode slurry. In some embodiment, this step can include synthesizing the electrode materials themselves.

At step 1002, the electrode can be formed. In some embodiments, this step can include coating an electrode slurry on a current collector. In some embodiments, the electrode or electrode layer can include electrode active materials, conductive carbon material, binders, and/or other additives. In some embodiments, the electrode active materials can include cathode active materials. In some embodiments, the cathode active materials can include high-nickel content (greater than or equal to about 80% Ni) lithium transition metal oxide. Such lithium transition metal oxides can include a particulate lithium nickel manganese cobalt oxide (“LiNMC”), lithium nickel cobalt aluminum oxide (“LiNCA”), lithium nickel manganese cobalt aluminum oxide (“LiNMCA”), lithium cobalt oxide (LCO), lithium manganese oxide (LMO), lithium metal phosphates like lithium iron phosphate (“LFP”), Lithium iron manganese phosphate (“LMFP”), and combinations thereof.

In some embodiments, the electrode active materials can include anode active materials. In some embodiments, the anode active materials can include graphitic carbon (e.g., ordered or disordered carbon with sp2 hybridization, artificial or natural Graphite, or blended), Li metal anode, silicon-based anode (e.g., silicon-based carbon composite anode, silicon metal, oxide, carbide, pre-lithiated), silicon-based carbon composite anode, lithium alloys (e.g., Li—Mg, Li—Al, Li—Ag alloy), lithium titanate, or combinations thereof. In some embodiments, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell may not comprise an anode active material in an uncharged state.

In some embodiments, the conductive carbon material can include graphite, carbon black, carbon nanotubes, Super P carbon black material, Ketj en Black, Acetylene Black, SWCNT, MWCNT, carbon nanofiber, graphene, and combinations thereof. In some embodiments, the binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”), carboxymethylcellulose (“CMC”), agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethyl enedi oxythi ophene) polystyrene sulfonate (PEDOT-P S S), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or combinations thereof.

After coating, the coated current collector can be dried to evaporate any solvent. In some embodiments, this step can include calendaring the coated current collectors. Calendaring can adjust the physical properties (e.g., bonding, conductivity, density, porosity, etc.) of the electrodes. In some embodiments, the electrode can then be sized via a slitting and/or notching machine to cut the electrode into the proper size and/or shape.

In some embodiments, solid electrolyte materials of the solid electrolyte layer can include inorganic solid electrolyte materials such as oxides, sulfides, phosphides, halides, ceramics, solid polymer electrolyte materials, hybrid solid state electrolytes, or glassy electrolyte materials, among others, or in any combinations thereof. In some embodiments, the solid electrolyte layer can include a polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B=Al, Ti), garnet-type with formula A₃B₂(XO₄)₃ (A=Ca, Sr, Ba and X=Nb, Ta), lithium phosphorous oxy-nitride (LixPOyNz), among others, or in any combinations thereof. In some embodiments, the solid electrolyte layer can include a glassy, ceramic and/or crystalline electrolyte material such as Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, lithium phosphorous oxy-nitride (LiₓPO_{y}N_{z}), lithium germanium phosphate sulfur (Li₁₀GeP₂S₁₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), Lithium lanthanum zirconium oxide (La₃Li₇O₁₂Zr₂), Li SiCON (Li2+2xZn1−xGeO4), lithium lanthanum titanate (Li3xLa2/3−xTiO3) and/or sulfide-based lithium argyrodites with formula Li₆PS₅X (X=Cl, Br) like Li₆PS₅Cl, among others, or in any combinations thereof. Furthermore, solid state polymer electrolyte materials can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), and PEG, among others, or in any combinations thereof.

At step 1003, the battery cell can be assembled. After the electrodes, separators, and/or electrolytes have been prepared, a battery cell can be assembled/prepared. In this step, the separator and/or an electrolyte layer can be assembled between the anode and cathode layers to form the internal structure of a battery cell. These layers can be assembled by a winding method such as a round winding or prismatic/flat winding, a stacking method, or a z-folding method.

The assembled cell structure can then be inserted into a cell housing which is then partially or completed sealed. In addition, the assembled structure can be connected to terminals and/or cell tabs (via a welding process). For battery cells utilizing a liquid electrolyte, the housed cell with the electrode structure inside it can also be filled with electrolyte and subsequently sealed.

Battery cells can have a variety of form factors, shapes, or sizes. For example, battery cells (and their housings/casings) can have a cylindrical, rectangular, square, cubic, flat, or prismatic form factor, among others. There are four main types of battery cells: (1) button or coin cells; (2) cylindrical cells; (3) prismatic cells; and (4) pouch cells. Battery cells can be assembled, for example, by inserting a winding and/or stacked electrode roll (e.g., a jellyroll) into a battery cell casing or housing. In some embodiments, the winded or stacked electrode roll can include the electrolyte material. In some embodiments, the electrolyte material can be inserted in the battery casing or housing separate from the electrode roll. In some embodiments, the electrolyte material includes, but is not limited to, an ionically conductive fluid or other material (e.g., a layer) that can allow the flow of electrical charge (i.e., ion transportation) between the cathode and anode. In some embodiments, the electrolyte material can include a non-aqueous polar solvent (e.g., a carbonate such as ethylene carbonate, propylene carbonate, diethyl carbonate, ethyl methyl carbonate, dimethyl carbonate, or a mixture of any two or more thereof). The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. In addition, the salt may be present in the electrolyte from greater than 0 M to about 0.5 M.

FIG. 17 depicts an illustrative example of a cross sectional view of a cylindrical battery cell 100. The cylindrical battery cell can include layers (e.g., sheet-like layers) of anode layers 10, separator and/or electrolyte layers 20, and cathode layers 30.

A battery cell can include at least one anode layer, which can be disposed within the cavity of the housing/casing. The battery cell can also include at least one cathode layer. The at least one cathode layer can also be disposed within the housing/casing. In some embodiments, when the battery cell is discharging (i.e., providing electric current), the at least one anode layer releases ions (e.g., lithium ions) to the at least one cathode layer generating a flow of electrons from one side to the other. Conversely, in some embodiments, when the battery cell is charging, the at least one cathode layer can release ions and the at least one anode layer can receive these ions.

These layers (cathode, anode, separator/electrolyte layers) can be sandwiched, rolled up, and/or packed into a cavity of a cylinder-shaped casing 40 (e.g., a metal can). The casings/housings can be rigid such as those made from metallic or hard-plastic, for example. In some embodiments, a separator layer (and/or electrolyte layer) 20 can be arranged between an anode layer 10 and a cathode layer 30 to separate the anode layer 20 and the cathode layer 30. In some embodiments, the layers in the battery cell can alternate such that a separator layer (and/or electrolyte layer) separates an anode layer from a cathode layer. In other words, the layers of the battery electrode can be (in order) separator layer, anode/cathode layer, separator layer, opposite of other anode/cathode layer and so on. The separator layer (and/or electrolyte layer) 20 can prevent contact between the anode and cathode layers while facilitating ion (e.g., lithium ions) transport in the cell. The battery cell can also include at least one terminal 50. The at least one terminal can be electrical contacts used to connect a load or charger to a battery cell. For example, the terminal can be made of an electrically conductive material to carry electrical current from the battery cell to an electrical load, such as a component or system of an electric vehicle as discussed further herein.

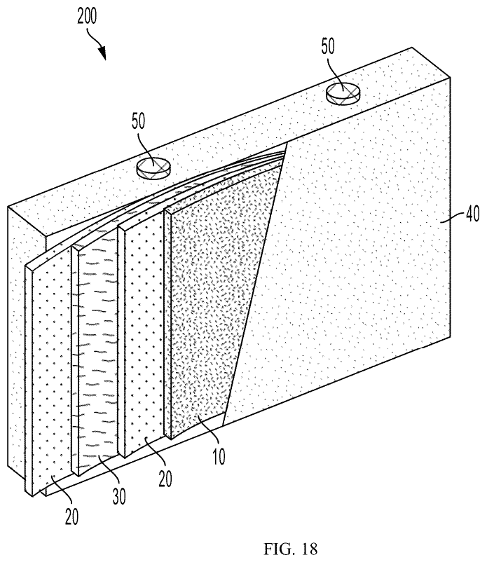

FIG. 18 depicts an illustrative example of a cross sectional view of a prismatic battery cell 200. The prismatic battery cell can include layers (e.g., sheet-like layers) of anode layers 10, separator and/or electrolyte layers 20, and cathode layers 30. Similar to the cylindrical battery cell, the layers of a prismatic battery cell can be sandwiched, rolled, and/or pressed to fit into cubic or rectangular cuboid (e.g., hyperrectangle) shaped casing/housing 40. In some embodiments, the layers can be assembled by layer stacking rather than jelly rolling. In some embodiments, the casing or housing can be rigid such as those made from a metal and/or hard-plastic. In some embodiments, the prismatic battery cell 200 can include more than one terminal 50. In some embodiments, one of these terminals can be the positive terminal and the other a negative terminal. These terminals can be used to connect a load or charger to the battery cell.

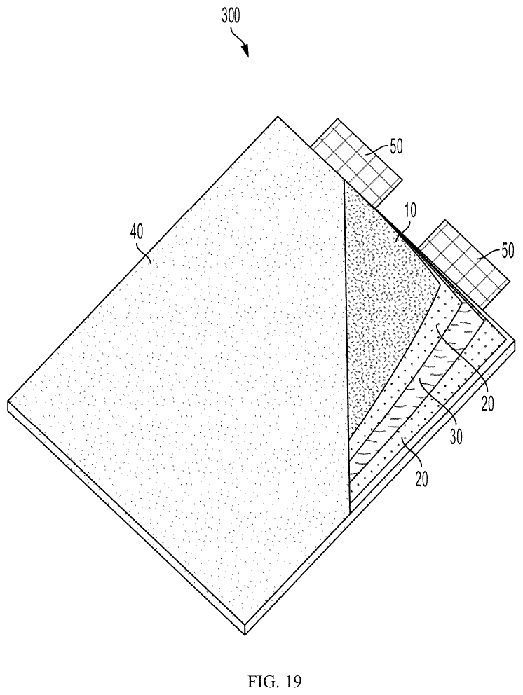

FIG. 19 depicts an illustrative example of a cross section view of a pouch battery cell 300. The pouch battery cells do not have a rigid enclosure and instead use a flexible material for the casing/housing 40. This flexible material can be, for example, a sealed flexible foil. The pouch battery cell can include layers (e.g., sheet-like layers) of anode layers 10, separator and/or electrolyte layers 20, and cathode layers 30. In some embodiments, these layers are stacked in the casing/housing. In some embodiments, the pouch battery cell 200 can include more than one terminal 50. In some embodiments, one of these terminals can be the positive terminal and the other the negative terminal. These terminals can be used to connect a load or charger to the battery cell.

The casings/housings of battery cells can include one or more materials with various electrical conductivity or thermal conductivity, or a combination thereof. In some embodiments, the electrically conductive and thermally conductive material for the casing/housing of the battery cell can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. In some embodiments, the electrically conductive and thermally conductive material for the housing of the battery cell can include a ceramic material (e.g., silicon nitride, silicon carbide, titanium carbide, zirconium dioxide, beryllium oxide, and among others) and/or a thermoplastic material (e.g., polyethylene, polypropylene, polystyrene, polyvinyl chloride, or nylon), among others.

At step 1004, the battery cell can be finalized. In some embodiments, this step includes the formation process wherein the first charging and discharging process for the battery cell takes place. In some embodiments, this initial charge and discharge can form a solid electrolyte interface between the electrolyte and the electrodes. In some embodiments, this step may cause some of the cells to produce gas which can be removed in a degassing process from the battery cell. In some embodiments, this step includes aging the battery cell. Aging can include monitoring cell characteristics and performance over a fixed period of time. In some embodiments, this step can also include testing the cells in an end-of-line (EOL) test rig. The EOL testing can include discharging the battery cells to the shipping state of charge, pulse testing, testing internal resistance measurements, testing OCV, testing for leakage, and/or optically inspecting the battery cells for deficiencies.

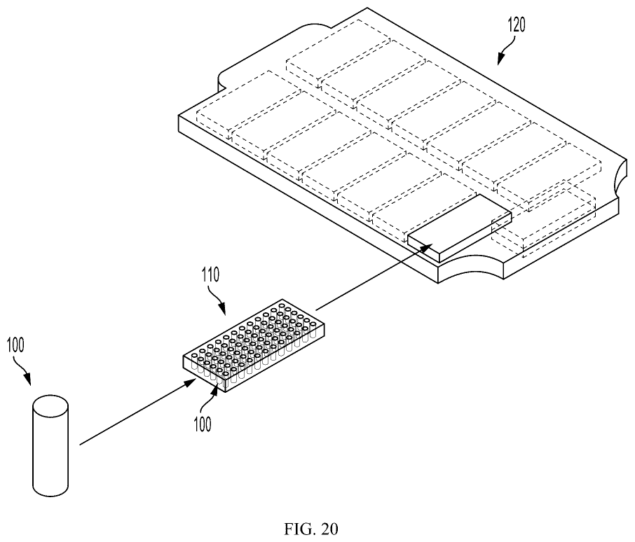

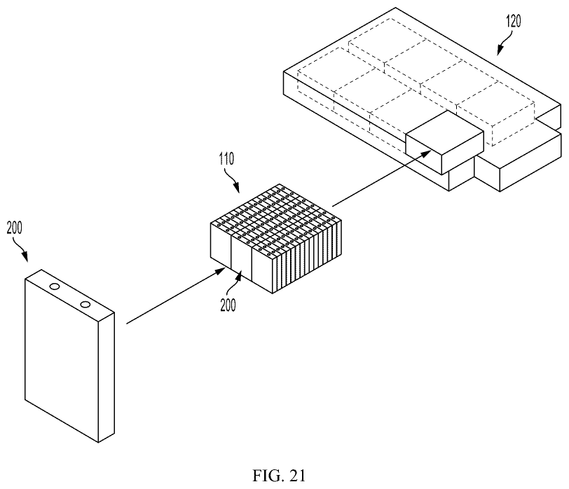

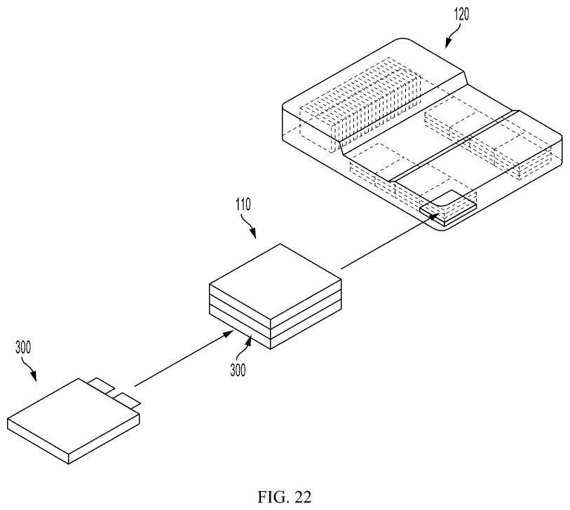

A plurality of battery cells (100, 200, and/or 300) can be assembled or packaged together in the same housing, frame, or casing to form a battery module and/or battery pack. The battery cells of a battery module can be electrically connected to generate an amount of electrical energy. These multiple battery cells can be linked to the outside of the housing, frame, or casing, through a uniform boundary. The battery cells of the battery module can be in parallel, in series, or in a series-parallel combination of battery cells. The housing, frame, or casing can protect the battery cells from a variety of dangers (e.g., external elements, heat, vibration, etc.). FIG. 20 illustrates cylindrical battery cells 100 being inserted into a frame to form battery module 110. FIG. 21 illustrates prismatic battery cells 200 being inserted into a frame to form battery module 110. FIG. 22 illustrates pouch battery cells 300 being inserted into a frame to form battery module 110. In some embodiments, the battery pack may not include modules. For example, the battery pack can have a “module-free” or cell-to-pack configuration wherein battery cells are arranged directly into a battery pack without assembly into a module.

A plurality of the battery modules 110 can be disposed within another housing, frame, or casing to form a battery pack 120 as shown in FIGS. 20-22. In some embodiments, a plurality of battery cells can be assembled, packed, or disposed within a housing, frame, or casing to form a battery pack (not shown). In such embodiments, the battery pack may not include a battery module (e.g., module-free). For example, the battery pack can have a module-free or cell-to-pack configuration where the battery cells can be arranged directly into a battery pack without assembly into a battery module. In some embodiments, the battery cells of the battery pack can be electrically connected to generate an amount of electrical energy to be provided to another system (e.g., an electric vehicle).

The battery modules of a battery pack can be electrically connected to generate an amount of electrical energy to be provided to another system (e.g., an electric vehicle). The battery pack can also include various control and/or protection systems such as a heat exchanger system (e.g., a cooling system) configured to regulate the temperature of the battery pack (and the individual modules and battery cells) and a battery management system configured to control the battery pack's voltage, for example. In some embodiments, a battery pack housing, frame, or casing can include a shield on the bottom or underneath the battery modules to protect the battery modules from external elements. In some embodiments, a battery pack can include at least one heat exchanger (e.g., a cooling line configured to distribute fluid through the battery pack or a cold plate as part of a thermal/temperature control or heat exchange).

In some embodiments, battery modules can collect current or electrical power from the individual battery cells that make up the battery modules and can provide the current or electrical power as output from the battery pack. The battery modules can include any number of battery cells and the battery pack can include any number of battery modules. For example, the battery pack can have one, two, three, four, five, six, seven, eight, nine, ten, eleven, twelve or other number of battery modules disposed in the housing/frame/casing. In some embodiments, a battery module can include multiple submodules. In some embodiments, these submodules may be separated by a heat exchanger configured to regulate or control the temperature of the individual battery module. For example, a battery module can include a top battery submodule and a bottom battery submodule. These submodules can be separated by a heat exchanger such as a cold plate in between the top and bottom battery submodules.

The battery packs can come in all shapes and sizes. For example, FIGS. 20-22 illustrates three differently shaped battery packs 120. As shown in FIGS. 20-22, the battery packs 120 can include or define a plurality of areas, slots, holders, containers, etc. for positioning of the battery modules. The battery modules can come in all shapes and sizes. For example, the battery modules can be square, rectangular, circular, triangular, symmetrical, or asymmetrical. In some examples, battery modules in a single battery pack may be shaped differently. Similarly, the battery module can include or define a plurality of areas, slots, holders, containers, etc. for the plurality of battery cells.

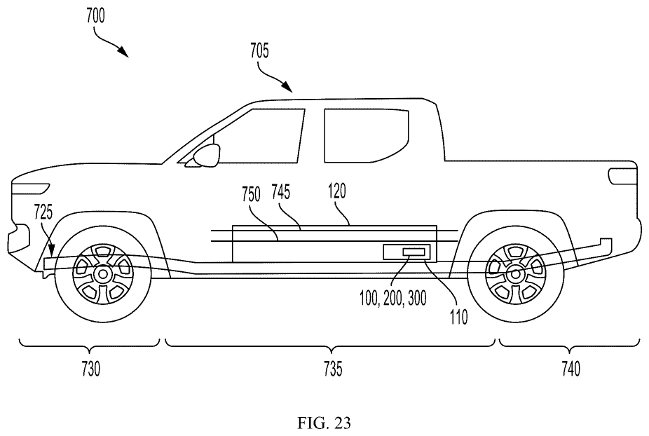

FIG. 23 illustrates an example of a cross sectional view 700 of an electric vehicle 705 that includes at least one battery pack 120. Electric vehicles can include, but are not limited to, electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. Electric vehicles can be fully electric or partially electric (e.g., plug-in hybrid) and further, electric vehicles can be fully autonomous, partially autonomous, or unmanned. In addition, electric vehicles can also be human operated or non-autonomous.

Electric vehicles 705 can be installed with a battery pack 120 that includes battery modules 110 with battery cells (100, 200, and/or 300) to power the electric vehicles. The electric vehicle 705 can include a chassis 725 (e.g., a frame, internal frame, or support structure). The chassis 725 can support various components of the electric vehicle 705. In some embodiments, the chassis 725 can span a front portion 730 (e.g., a hood or bonnet portion), a body portion 735, and a rear portion 740 (e.g., a trunk, payload, or boot portion) of the electric vehicle 705. The battery pack 120 can be installed or placed within the electric vehicle 705. For example, the battery pack 120 can be installed on the chassis 725 of the electric vehicle 705 within one or more of the front portion 730, the body portion 735, or the rear portion 740. In some embodiments, the battery pack 120 can include or connect with at least one busbar, e.g., a current collector element. For example, the first busbar 745 and the second busbar 750 can include electrically conductive material to connect or otherwise electrically couple the battery pack 120 (and/or battery modules 110 or the battery cells 100, 200, and/or 300) with other electrical components of the electric vehicle 705 to provide electrical power to various systems or components of the electric vehicle 705. In some embodiments, battery pack 120 can also be used as an energy storage system to power a building, such as a residential home or commercial building instead of or in addition to an electric vehicle.

The present invention, thus generally described, will be understood more readily by reference to the following examples, which are provided by way of illustration and are not intended to be limiting of the present invention.

### EXAMPLES

### Example 1—Electrode Containing Carbon Nanotube Microchannels

Described herein is a method to prepare an electrode comprising a current collector; a first base layer on a first surface of the current collector, wherein the first base layer comprises microchannels; and a first active material layer on the first base layer; wherein at least a portion of the microchannels of the first base layer are at least partially horizontally aligned with respect to the first surface of the current collector.

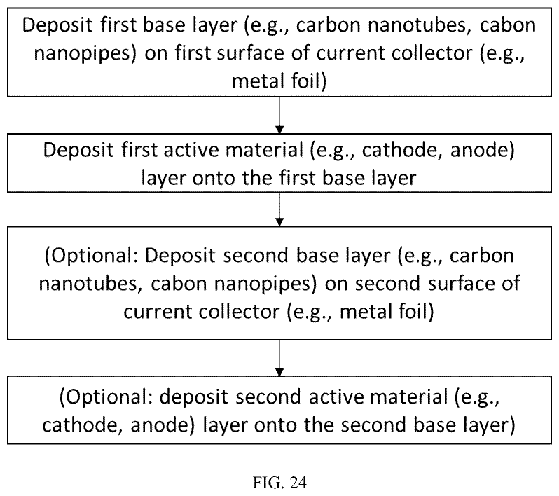

FIG. 24 is a process flow diagram for the method described herein. As an illustration of the method, a metallic foil sheet, such as a copper foil sheet is used as the current collector. The first step in the method may be to deposit a base layer onto a first surface of the copper foil sheet. For example, the first base layer may comprise carbon nanotubes. Carbon nanotubes can be deposited on the copper foil sheet by various processes known to those of ordinary skill in the art. In this example, chemical vapor deposition is used to deposit a first base layer of carbon nanotubes on the copper foil sheet.

The interior space of the carbon nanotubes provides microchannels in the first base layer. A further step in the method may comprise applying a gas flow, acoustic field, magnetic field, or electric field to at least partially align the microchannels in a horizontal alignment with respect to the first surface of the current collector.

Subsequently, a first active layer material may be deposited onto the first base layer of carbon nanotubes. In this example, the first active material layer is an anode active material layer (e.g., a graphitic carbon). For example, graphite may be deposited onto the first base layer comprising carbon nanotubes.

### Example 2—Electrode Containing Cathode and Anode Microchannels

Described herein is a second method to prepare an electrode comprising a current collector; a first base layer on a first surface of the current collector, wherein the first base layer comprises microchannels; and a first active material layer on the first base layer; wherein at least a portion of the microchannels of the first base layer are at least partially horizontally aligned with respect to the first surface of the current collector.

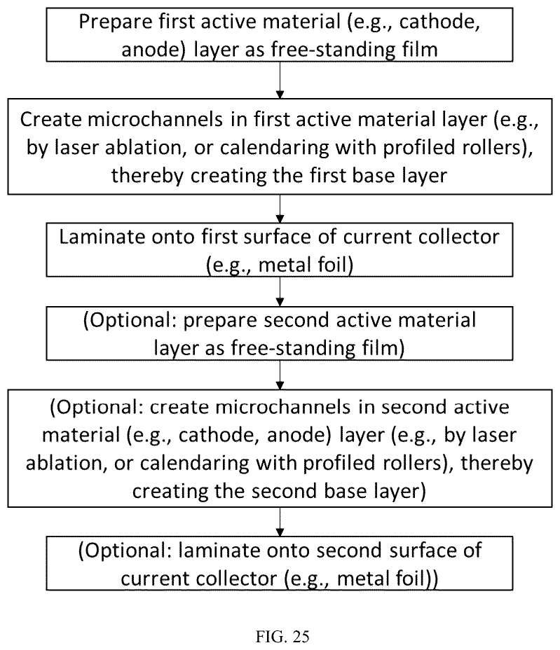

FIG. 25 is a process flow diagram for the method described herein. As an illustration of the method, a metallic foil sheet, such as a aluminum foil sheet is used as the current collector. The first step in the method may be to create microchannels in an active material, thereby producing the first base layer. The first step is to create microchannels in a cathode active material, for example an olivine-type material such as a lithium metal phosphate. In this example, microchannels are created in a lithium iron phosphate cathode active material. First, lithium iron phosphate cathode active material is provided as a free-standing film. The microchannels can then be created using various techniques known to a person of ordinary skill in the art. For example, laser ablation may be used to create the microchannels in the lithium iron phosphate cathode active material. This process creates a first base layer out of the active material, the first base layer is contiguous with the first active material layer (i.e, the remainder of the lithium iron phosphate). Subsequently, the first base layer is laminated onto the first surface of the current collector (i.e., the aluminum foil sheet).

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. An electrode comprising:
a current collector;
a first base layer on a first surface of the current collector, wherein the first base layer comprises microchannels; and
a first active material layer on the first base layer;
wherein at least a portion of the microchannels of the first base layer are at least partially horizontally aligned with respect to the first surface of the current collector.

2. The electrode of claim 1, further comprising:
a second base layer on a second surface of the current collector, wherein the second base layer comprises microchannels; and
a second active material layer on the second base layer;
wherein at least a portion of the microchannels of the second base layer are at least partially horizontally aligned with respect to the second surface of the current collector.

3. The electrode of claim 1, wherein a cross-section of each of the microchannels is circular or polygonal.

4. The electrode of claim 1, wherein the microchannels are arranged in a staggered or honeycomb structure.

5. The electrode of claim 1, wherein the average orientation of the microchannels is parallel to a long axis of the first surface.

6. The electrode of claim 1, wherein the average orientation of the microchannels is parallel to a short axis of the first surface.

7. The electrode of claim 1, wherein the thickness of the first base layer is less than about 10 μm.

8. The electrode of claim 1, wherein the surface area of the first base layer is greater than 50% of the area of the first surface of the current collector, greater than 75% of the area of the first surface of the current collector, greater than 90% of the area of the first surface of the current collector, greater than 95% of the area of the first surface of the current collector, or greater than 99% of the area of the first surface of the current collector, or greater than 99.9% of the area of the first surface of the current collector.

9. The electrode of claim 1, wherein the first base layer is patterned, wherein the pattern consists of two or more discontinuous regions of the first base layer.

10. The electrode of claim 9, wherein the first base layer comprises cathode material or anode material, and wherein the microchannels of the first base layer consist of voids within the cathode material or the anode material.

11. The electrode of claim 10, wherein the voids are produced by laser ablation of the cathode material or the anode material.

12. The electrode of claim 10, wherein the voids are produced by calendaring the cathode material or the anode material with profiled rollers.

13. The electrode of claim 1, wherein the first base layer comprises:
carbon nanotubes;
carbon nanopipes; or a combination thereof.

14. The electrode of claim 13, wherein the first base layer is produced by chemical vapor deposition.

15. A method of preparing an electrode, comprising:
depositing a first base layer on a first surface of a current collector, wherein the first base layer comprises microchannels; and
depositing a first active material layer on the first base layer;
wherein at least a portion of the microchannels of the first base layer are at least partially horizontally aligned with respect to the first surface of the current collector.

16. The method of claim 15, further comprising:
depositing a second base layer on a second surface of the current collector, wherein the second base layer comprises microchannels; and
depositing a second active material layer on the second base layer;
wherein at least a portion of the microchannels of the second base layer are at least partially horizontally aligned with respect to the second surface of the current collector.

17. The method of claim 15, wherein depositing the first base layer comprises performing chemical vapor deposition or arc discharge.

18. The method of claim 15, further comprising applying a gas flow, acoustic field, magnetic field, or electric field to at least partially align the microchannels of the first base layer.

19. A method of preparing an electrode comprising:
a current collector;
a first base layer on a first surface of the current collector, wherein the first base layer comprises microchannels; and
a first active material layer on the first base layer;
wherein at least a portion of the microchannels of the first base layer are at least partially horizontally aligned with respect to the first surface of the current collector;
said method comprising:
creating microchannels in an active material, thereby producing the first base layer;
wherein the first base layer is contiguous with the first active material layer; and
laminating the first base layer onto a first surface of the current collector.

20. The method of claim 19, wherein creating microchannels in the active material comprises:
performing laser ablation of the active material;
calendaring the cathode material or the anode material with profiled rollers; or a combination thereof.
